(19) United States
(12) Patent Application Publication
(10) Pub. No.: US 2016/0125715 A1
(43) Pub. Date: May 5, 2016

(54) ELECTRONIC DEVICE AND ALARM METHOD OF THE ELECTRONIC DEVICE

(71) Applicant: FIH (HONG KONG) LIMITED, Kowloon (HK)

(72) Inventor: YI-CHIA LEE, New Taipei (TW)

(21) Appl. No.: 14/729,539

(22) Filed: Jun. 3, 2015

(30) Foreign Application Priority Data
Oct. 30, 2014 (TW) 103137543

(51) Int. Cl. G08B 21/02; G08B 25/00

(52) U.S. Cl. CPC G08B 21/02; G08B 25/008

(57) ABSTRACT

In a method for an electronic device to issue an alarm, the electronic device determines whether alarm detection status is enabled or disabled. If enabled, location information of the electronic device is acquired at predetermined time intervals and a current location of the electronic device is stored. The electronic device further detects whether the electronic device needs to execute an alarm. When an alarm is required, the electronic device executes the alarm by performing preset operations. The preset operations include sending preset information to designated contacts in a preset mode, and the preset information includes current location of the electronic device.

### CROSS-REFERENCE TO RELATED APPLICATIONS

This application claims priority to Taiwan Patent Application No. 103137543 filed on Oct. 30, 2014, the contents of which are incorporated by reference herein.

### FIELD

The subject matter herein generally relates to alarm technology, and particularly to an electronic device and an alarm method of the electronic device.

### BACKGROUND

A user can ask for help timely when the user encounters unexpected issues (for example, accidents). Sometimes, the user needs to operate a preset trigger switch for outputting an alarm or send a message to ask for help. However, it is difficult for the user to ask for help secretly and fast.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of an electronic device including an alarm system.

FIG. 2 is a diagrammatic view of an example embodiment of a setting of a user interface.

FIG. 3 is a diagrammatic view of an example embodiment of a main user interface.

FIG. 4 is a flowchart of an example embodiment of an alarm method of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or computing modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series, and the like.

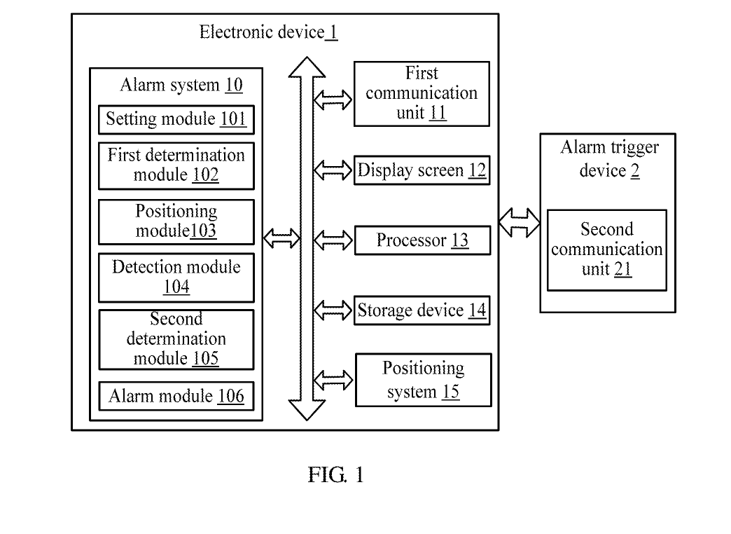

FIG. 1 illustrates a block diagram of an example embodiment of an electronic device. In at least one embodiment, as shown in FIG. 1, an electronic device 1 can include, but is not limited to, an alarm system 10, a first communication unit 11, a display screen 12, at least one processor 13, a storage device 14, and a positioning system 15. FIG. 1 illustrates only one example of the electronic device 1, other examples can comprise more or fewer components than those shown in the embodiment, or have a different configuration of the various components.

The display screen 12 can display data of the electronic device 1. The at least one processor 13 executes one or more computerized codes and other applications of the electronic device 1 to provide functions of the electronic device 1. The storage device 14 can be an internal storage device, such as a random access memory (RAM) for temporary storage of information, and/or a read only memory (ROM) for permanent storage of information. The storage device 14 can also be an external storage device, such as an external hard disk, a storage card, or a data storage medium.

In at least one embodiment, the electronic device 1 can communicate with an alarm trigger device 2 through the first communication unit 11 and a second communication unit 21 in the alarm trigger device 2. Each of the first communication unit 11 and the second communication unit 21 may be a BLUETOOTH™ module or a wireless card, for example. The alarm trigger device 2 can be an earphone which can be inserted into an earphone socket (not shown) of the electronic device 1, and the electronic device 1 provides a power for the alarm trigger device 2 to make the first communication unit 11 match the second communication unit 21 successfully. The positioning system 15 can provide location information of the electronic device 1. For example, the positioning system 15 is a Global Positioning System (GPS) device.

In at least one embodiment, the alarm system 10 can include, but is not limited to, a setting module 101, a first determination module 102, a positioning module 103, a detection module 104, a second determination module 105, and an alarm module 106. The modules 101-106 can include computerized instructions in the form of one or more computer-readable programs that can be stored in a non-transitory computer-readable medium, such as the storage device 14, and be executed by the at least one processor 13 of the electronic device 1.

The setting module 101 sets preset operations performed by the electronic device 1 when the electronic device 1 needs to execute an alarm. In at least one embodiment, the preset operations can include sending preset information to designated contacts in a preset mode (for example, sending every 5 minutes) and playing a designated alarm ring. The preset information can include location information of the electronic device 1. In other embodiments, the preset operations can further include making a call to a designated contact.

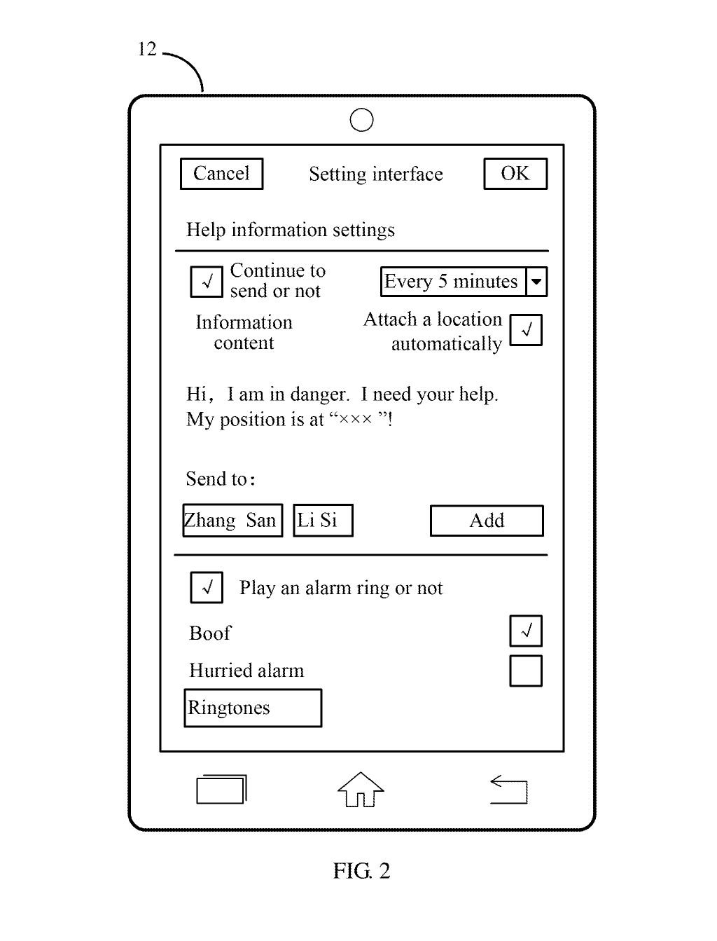

In at least one embodiment, the alarm system 10 provides a setting user interface displayed on the display screen 12 for a user of the electronic device 1 to set and configure the preset operations. As shown in FIG. 2, the setting user interface can include settings of contents of the preset information, the preset mode, and the designated contacts. For example, when the alarm is confirmed, the electronic device 1 can send the preset information of “Hi , I am in danger. I need your help. My position is at ‘xxx’!” to the designated contacts “Zhang San” and “Li Si” every 5 minutes. The strings of “xxx” in the preset information represent the location of the electronic device 1. The setting user interface can further allow a selection of whether to play an alarm ring or not. In at least one embodiment, the alarm ring can be bark, hurried alarm, and ringtones, for example.

The first determination module 102 determines whether an alarm detection status of the electronic device 1 is enabled. In at least one embodiment, the first determination module 102 determines the alarm detection status according to a connection between the electronic device 1 and the alarm trigger device 2. If the first communication unit 11 matches the second communication unit 21 successfully, which indicates that the alarm trigger device 2 is connected to the electronic device 1 successfully, the electronic device 1 is in the alarm detection status and the first determination module 102 determines that the alarm detection status is enabled.

In other embodiment, the first determination module 102 can determine the alarm detection status according to other conditions. For example, if one or more preset keystrokes or virtual keystrokes are pressed or a preset trigger signal (for example, a vigorous shaking) of the electronic device 1 or of the alarm trigger device 2 is received, the first determination module 102 determines that the alarm detection status is enabled.

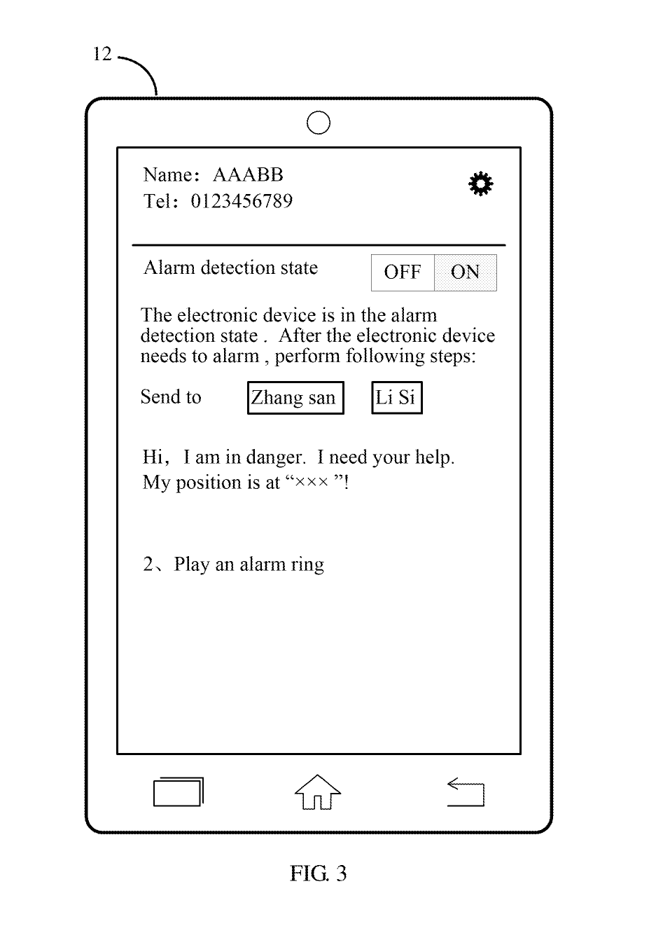

To avoid misoperations from the user, after the alarm detection status is enabled, the alarm system 10 can further provide a main user interface for the user to confirm the preset operations and to select disablement of the alarm detection status. As shown in FIG. 3, the main user interface displays the preset operations which is required to be performed by the electronic device 1, and provides a button for enabling (e.g., an “On” button) and a button for disabling (e.g., an “Off” button) the alarm detection status. When the user does not require the electronic device 1 to enter the alarm detection status, the user can operate the “Off” button to disable the alarm detection status.

After the alarm detection status is enabled, the positioning module 103 acquires the location of the electronic device 1 from the positioning system 15 at predetermined time intervals, and stores a current location of the electronic device 1 temporarily in the storage device 14.

The detection module 104 detects whether the electronic device 1 needs to execute an alarm. In at least one embodiment, the detection module 104 determines whether the electronic device 1 needs to execute an alarm according to the disconnection between the electronic device 1 and the alarm trigger device 2. Once the alarm trigger device 2 is disconnected from the electronic device 1, that is, the first communication unit 11 and the second communication unit 21 do not match successfully, the detection module 104 may determine that the electronic device 1 needs to execute an alarm. For example, if the alarm trigger device 2 is extracted out from an earphone socket of the electronic device 1, and the electronic device 1 does not provide a power for the alarm trigger device 2, then the first communication unit 11 does not match the second communication unit 21 successfully.

In other embodiment, the detection module 104 determines whether the electronic device 1 needs to execute an alarm according to other conditions. For example, if one or more preset keystrokes or virtual keystrokes are not pressed again during a preset time period or a preset cancelling signal is not received during a preset time period, the detection module 104 determines that the electronic device 1 needs to execute an alarm.

After the detection module 104 determines that the electronic device 1 needs to execute an alarm, the second determination module 105 further determines whether the alarm detection status is disabled. In at least one embodiment, if the “Off” button is selected by the user, the second determination module 105 determines that the alarm detection status is disabled. Otherwise, the second determination module 105 determines that the alarm detection status is still enabled.

When the second determination module 105 determines that the alarm detection status is enabled, the alarm module 106 executes the alarm according to the preset operations. For example, the alarm module 106 reads a current location of the electronic device 1 from the storage device 14, and sends the preset information including the current location to designated contacts according to a preset mode (for example, sending every 5 minutes) and playing a designated alarm ring. In at least one embodiment, the alarm module 106 can insert the current location into a preset position (for example, the position of “xxx”) of the preset information to update the location of the electronic device 1 in the preset information.

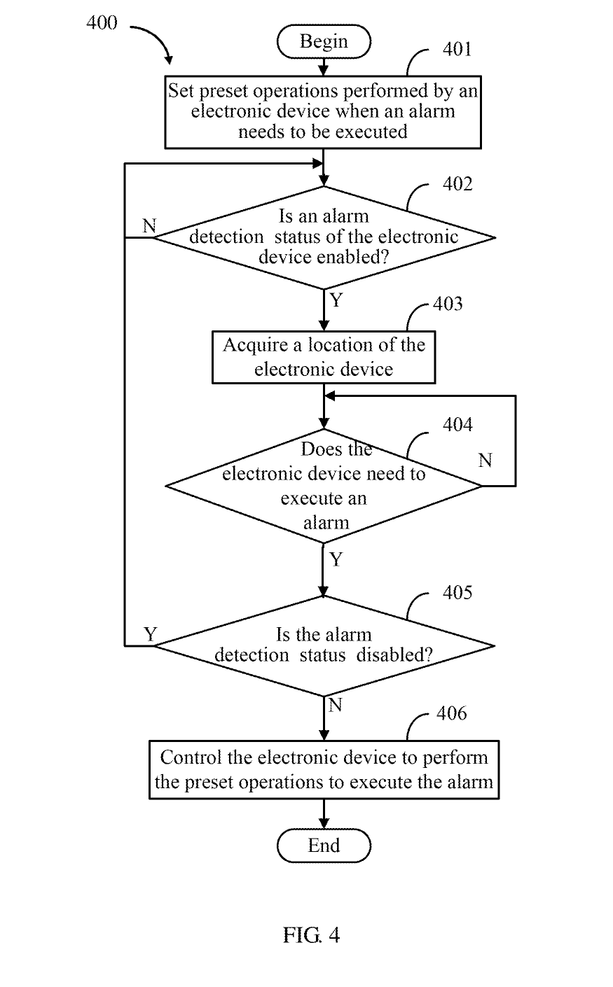

Referring to FIG. 4, a flowchart is presented in accordance with an example embodiment. An example method 400 is provided by way of example, as there are a variety of ways to carry out the method. The example method 400 described below can be carried out using the configurations illustrated in FIGS. 1-3, for example, and various elements of these figures are referenced in explaining the example method 400. Each block shown in FIG. 4 represents one or more processes, methods, or subroutines, carried out in the example method 400. Furthermore, the illustrated order of blocks is illustrative only and the order of the blocks can be changed. Additional blocks can be added or fewer blocks can be utilized without departing from this disclosure. The example method 400 can begin at block 401.

At block 401, a setting module sets preset operations to be performed by the electronic device 1 when the electronic device 1 needs to execute an alarm. In at least one embodiment, the preset operations can include sending preset information to designated contacts in a preset mode (for example, sending every 5 minutes) and playing a designated alarm ring. The preset information can include location information of the electronic device 1. In other embodiments, the preset operations can include making a call to a designated contact. In at least one embodiment, the alarm system 10 provides a setting user interface displayed on the display screen 12 for a user of the electronic device 1 to set and configure the preset operations.

At block 402, a first determination module determines whether an alarm detection status of the electronic device 1 is enabled. In at least one embodiment, the first determination module determines the alarm detection status according to a connection between the electronic device 1 and the alarm trigger device 2. If the first communication unit 11 matches the second communication unit 21 successfully, which indicates that the alarm trigger device 2 connects to the electronic device 1 successfully, the electronic device 1 is in the alarm detection status and the first determination module determines that the alarm detection status is enabled. If the alarm detection status is determined to be enabled, block 403 is implemented.

At block 403, a positioning module acquires the location of the electronic device 1 from the positioning system 15 at each predetermined time interval, and stores the current location of the electronic device 1 temporarily in the storage device 14.

At block 404, a detection module detects whether the electronic device 1 needs to execute an alarm. In at least one embodiment, the detection module determines whether the electronic device 1 needs to execute an alarm according to the disconnection between the electronic device 1 and the alarm trigger device 2. Once the alarm trigger device 2 disconnects to the electronic device 1, the detection module may determine that the electronic device 1 needs to execute an alarm, and block 405 is implemented. Otherwise, block 404 is repeated.

At block 405, a second determination module determines whether the alarm detection status is disabled. In at least one embodiment, if the “Off” button is selected by the user, the second determination module determines that the alarm detection status is disabled, and block 402 is implemented. Otherwise, the second determination module determines that the alarm detection status is enabled, and block 406 is implemented.

At block 406, an alarm module controls the electronic device to execute the alarm by performing the preset operation. For example, the alarm module reads the current location of the electronic device 1 from the storage device 14, and sends the preset information including current location to designated contacts in a preset mode (for example, sending every 5 minutes) and playing a designated alarm ring. In at least one embodiment, the alarm module can insert the current location into a preset position (for example, the position of “xxx”) of the preset information to update the location of the electronic device 1 in the preset information.

All of the processes described above can be embodied in, and fully automated via, functional code modules executed by one or more general purpose processors such as the processor 13. The code modules can be stored in any type of non-transitory readable medium or other storage device such as the storage device 14. Some or all of the methods can alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications can be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. An electronic device comprising:
a display screen;
at least one processor coupled to the display screen; and
a storage device that stores one or more programs which, when executed by the at least one processor, cause the at least one processor to:
determine whether an alarm detection status is enabled;
acquire location information of the electronic device from a positioning system at predetermined time intervals in event that the alarm detection status is enabled, and store a current location of the electronic device;
detect whether the electronic device needs to execute an alarm; and
execute the alarm by performing preset operations when the electronic device needs to execute the alarm, the preset operations comprising sending preset information to designated contacts with a preset mode, and the preset information comprising the current location of the electronic device.

2. The electronic device of claim 1, wherein the at least one processor determines that the alarm detection status is enabled when the electronic device connects to an alarm trigger device and when a first communication unit of the electronic device successfully matches a second communication unit of the alarm trigger device.

3. The electronic device of claim 2, wherein the at least one processor determines that the electronic device needs to execute the alarm when the alarm trigger device disconnects to the electronic device or when the first communication unit does not match successfully the second communication unit.

4. The electronic device of clam 1, wherein the at least one processor further:
provides a setting user interface displayed on a display screen of the electronic device to set the preset operation; and
provides a main user interface for a user to confirm the preset operations and to determine whether to disable the alarm detection status.

5. The electronic device of claim 4, wherein the at least one processor further:
determines whether the alarm detection status is disabled after the electronic device is determined to need to execute an alarm;
executes the alarm by performing the preset operations when the alarm detection status is enabled; and
cancels the alarm to be executed when the alarm detection status is determined to be disabled.

6. The electronic device of claim 1, wherein the preset operations further comprises playing a designated alarm ring.

7. A computer-based alarm method of an electronic device, the method being executed by at least one processor of the electronic device, the method comprising:
determining whether an alarm detection status of the electronic device is enabled;
acquiring location information of the electronic device from a positioning system of the electronic device at each predetermined time interval when the alarm detection status is enabled, and storing a current location of the electronic device;
detecting whether the electronic device needs to execute an alarm; and
executing the alarm by performing preset operations when the electronic device needs to execute the alarm, the preset operations comprising sending preset information to designated contacts with a preset mode, and the preset information comprising the current location of the electronic device.

8. The method of claim 7, wherein the alarm detection status is determined to be enabled when the electronic device connects to an alarm trigger device and when a first communication unit of the electronic device successfully matches a second communication unit of the alarm trigger device.

9. The method of claim 8, wherein the electronic device is determined to need to execute the alarm when the alarm trigger device disconnects to the electronic device or when the first communication unit does not match successfully the second communication unit.

10. The method of claim 7, further comprising:
providing a setting user interface displayed on a display screen of the electronic device to set the preset operation; and
providing a main user interface for a user to confirm the preset operations and to determine whether to disable the alarm detection status.

11. The method of claim 10, further comprising:
determining whether the alarm detection status is disabled after the electronic device is determined to need to execute an alarm;
executing the alarm by performing the preset operations when the alarm detection status is enabled; and
canceling the alarm to be executed when the alarm detection status is determined to be disabled.

12. The method of claim 7, wherein the preset operations further comprises playing a designated alarm ring.

13. A non-transitory computer-readable medium having stored thereon instructions that, when executed by at least one processor of an electronic device, causing the electronic device to perform an alarm method, the method comprising:
determining whether an alarm detection status of the electronic device is enabled;
acquiring location information of the electronic device from a positioning system of the electronic device at each predetermined time interval when the alarm detection status is enabled, and storing a current location of the electronic device;
detecting whether the electronic device needs to execute an alarm;
executing the alarm by performing preset operations when the electronic device needs to execute the alarm, the preset operations comprising sending preset information to designated contacts with a preset mode, and the preset information comprising the current location of the electronic device.

14. The non-transitory computer-readable medium of claim 13, wherein the alarm detection status is determined to be enabled when the electronic device connects to an alarm trigger device and when a first communication unit of the electronic device successfully matches a second communication unit of the alarm trigger device.

15. The non-transitory computer-readable medium of claim 14, wherein the electronic device is determined to need to execute the alarm when the alarm trigger device disconnects to the electronic device or when the first communication unit does not match successfully the second communication unit.

16. The non-transitory computer-readable medium of claim 13, wherein the method further comprises:
providing a setting user interface displayed on a display screen of the electronic device to set the preset operation; and
providing a main user interface for a user to confirm the preset operations and to determine whether to disable the alarm detection status.

17. The non-transitory computer-readable medium of claim 16, wherein the method further comprises:
determining whether the alarm detection status is disabled after the electronic device is determined to need to execute an alarm;
executing the alarm by performing the preset operations when the alarm detection status is enabled; and
canceling the alarm to be executed when the alarm detection status is determined to be disabled.

18. The non-transitory computer-readable medium of claim 13, wherein the preset operations further comprises playing a designated alarm ring.
